(19) United States
(12) Patent Application Publication
(10) Pub. No.: US 2007/0217879 A1
(43) Pub. Date: Sep. 20, 2007

(54) Core Drilling Device With Electrical Feeding That Is Manually Controlled

(76) Inventor: Martin Larsson, Ojersjo (SE)

Correspondence Address: PEARNE & GORDON LLP, 1801 EAST 9TH STREET, SUITE 1200, CLEVELAND, OH, 44114-3108, US

(21) Appl. No.: 10/594,611

(22) PCT Filed: Mar. 30, 2005
(86) PCT No.: PCT/SE05/00472

§ 371 Date: Apr. 27, 2007

(30) Foreign Application Priority Data
Mar. 31, 2004 (SE) 0400859-5

(51) Int. Cl. B23B 47/06

(52) U.S. Cl. 408/129

(57) ABSTRACT

A core-drilling device (10) comprising a drilling machine (3) with a core drill (4), a drill stand (2), a feeding housing suspending the drilling machine and which is movable along the stand, an electric drilling motor for rotation of the core drill in the drilling machine and a feeding unit (19) with an electric feeding motor (17) for the feeding of the feeding housing along the stand. A control unit (30), which is electrically connected to the feeding unit, comprises at least a first control (33) for manual influence of the feeding motor's (17) feeding force.

### TECHNICAL FIELD

The present invention relates to a core-drilling device comprising a drilling machine with a core drill, a drill stand, a feeding housing that supports the drilling machine and that is movable along the stand, an electric drilling motor for the rotation of the core drill in the drilling machine and a feeding unit with an electric feeding motor for the feeding of the feeding housing along the stand. A control unit is electrically connected to the feeding unit, the mentioned control unit comprising at least a first control for manual influence of the feeding motor's feeding force.

### TECHNICAL BACKGROUND

Automatically operating core-drilling devices of the above-mentioned type are known. A problem with this known device is however that the initial phase of the drilling operation has not been possible to automate in a satisfactory way. The reason is that the tube-shaped core drill, which can have a very large diameter, easily slides sideways when a section of the core drilling head firstly comes in contact with the drilling object. Therefore the initial drilling phase is usually carried out manually, whereby the operator by means of skill and experience can counteract such unintentional deviations from the intended drilling direction and carefully establish a ring-shaped groove to the necessary depth in the drilling object so that the remaining drilling can be carried out automatically guided by the established groove. Apart from the fact that the initial, manual operation is difficult to carry out and requires skill and experience, it has also in many cases ergonomic disadvantages, especially when the drilling holes are to be established in inaccessible locations, such as in ceilings, close to corners and so on, which may require ladders etc.

### DESCRIPTION OF THE INVENTION

The purpose of the invention is to resolve the above-mentioned problem. According to a first aspect of the invention, this is achieved by means of a control unit that is electrically connected to the feeding unit, this feeding unit comprising at least a first control for manual influence of the feeding force of the feeding motor. According to a preferred embodiment, the control unit constitutes a portable unit, for instance in the form of a relatively small box that via at least one cable and/or via radio communication is electrically connected to the feeding unit. This makes it possible, even during the initial critical drilling phase, to remote control the core-drilling device, which can imply both ergonomic and safety related advantages. This does not however mean that the control unit cannot be located on the feeding unit or at any other location on the device, but rather means a freedom from such a mounting.

Further characterisation and aspects of the invention are described in the independent patent claims and the following description of an embodiment.

### SHORT DESCRIPTION OF THE FIGURES

In following description of an embodiment, reference to the enclosed drawing figures is made, of which

FIG. 1 shows a side view of a known core-drilling device,

FIG. 2 shows a perspective view of elements included in the core-drilling device according to the preferred embodiment of the invention,

FIG. 3 shows a control unit in larger scale and

FIG. 4 illustrates the control principle of the core-drilling device according to the invention by means of a schematically presented block diagram.

### DESCRIPTION OF THE PREFERRED EMBODIMENT

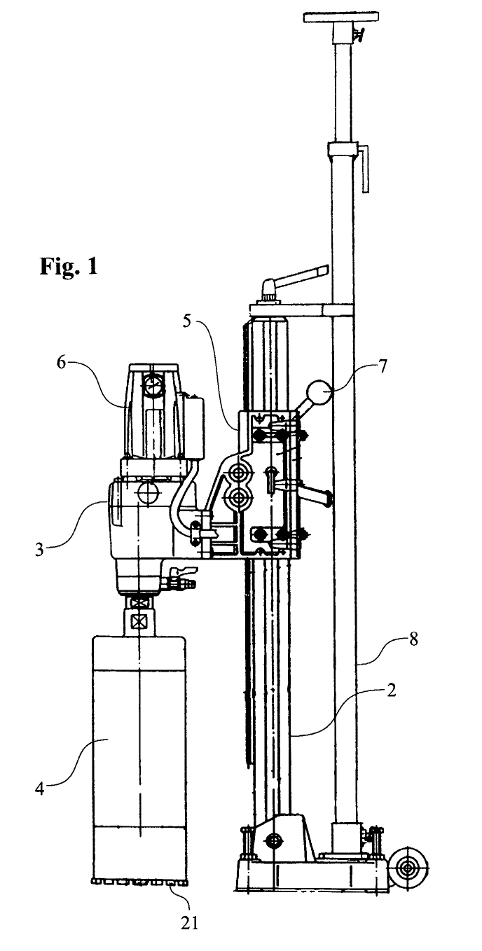

With reference to at first FIG. 1, a known core-drilling device is generally designated with the FIG. 1. The main parts of the device comprises a drill stand 8 with a pillar 2, a drilling machine 3 with a core drill 4, a feeding housing 5 suspending the machine 3 and that is movable along the pillar 2, a drilling motor 6 for the rotation of the core drill in the drilling machine and a feeding handle 7 for manual feeding of the feeding housing along the pillar 2. In the illustrated case, the drill stand 8 is vertical, but can be adjusted to different angles relative the plane of the floor. Core-drilling devices with horizontal drill stands are also known and useable in conjunction with the invention.

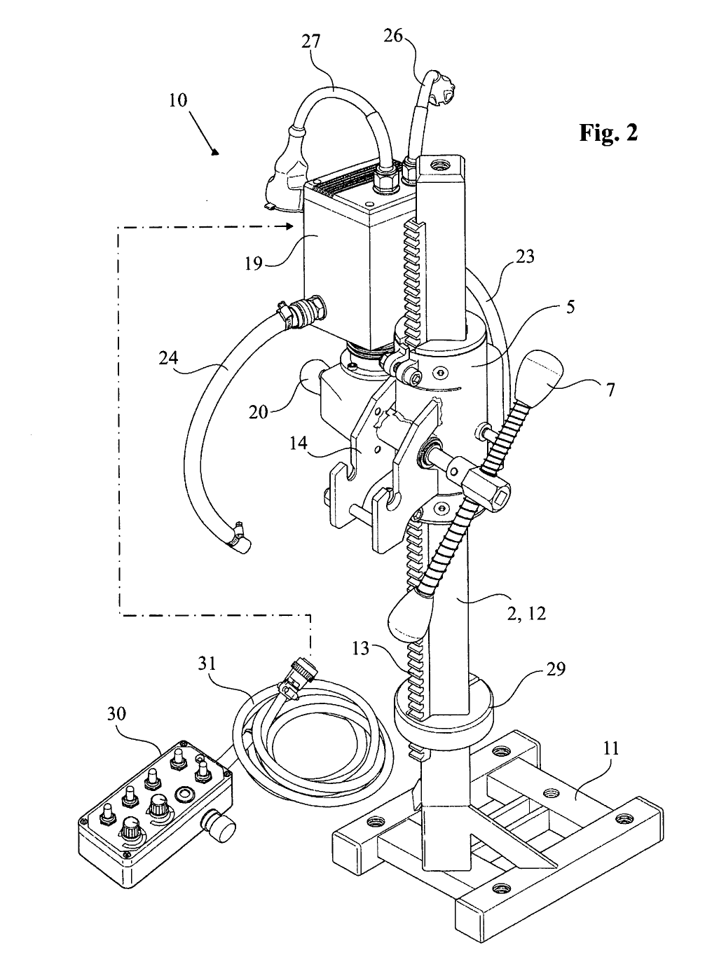

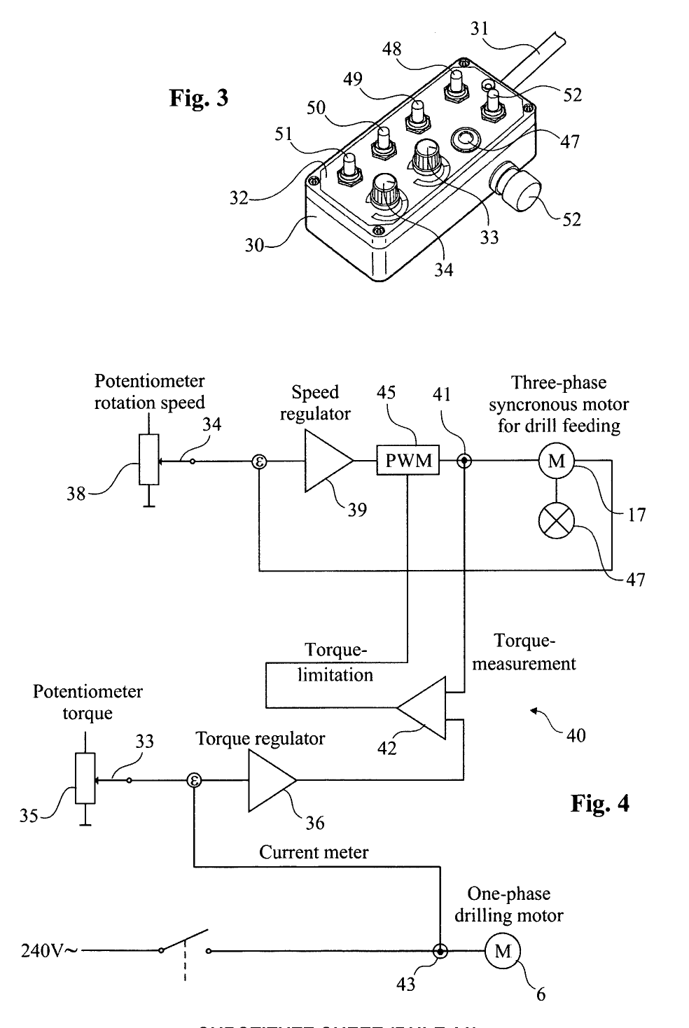

The core-drilling device 10 according to the invention, FIG. 2, can be used in connection with a drill stand 8 of the sort shown in FIG. 1 and that has been briefly described above. It can also be used without a special stand. However, the core-drilling device comprises a pillar 2 in the same way as the known core-drilling device 1, FIG. 1. As shown in FIG. 2, pillar 2 is connected with a footplate 11 that can be bolted to the floor or to a wall or fitted on a stand that in turn is anchored in a suitable manner. When pillar 2 is used without a special stand 8, the pillar 2 can be seen as an integrated pillar and stand. The pillar 2 has the shape of a guide 12 with a square cross section. On guide 12 there is a rack 13 and a feeding housing 5. On feeding housing 5 there are a couple of brackets that can suspend the not shown drilling machine 3, FIG. 1, via a quick coupling, comprising female parts as shown in the brackets 14 in FIG. 2.

The feeding housing 5, and thereby the drilling machine 3 with the drilling motor 6 and the drill 4, can be fed along the stand/pillar 2 either manually by means of a handle 16 or, not shown in FIG. 2, a feeding motor 17, FIG. 4, arranged in a feeding unit 19. Whether the feeding is manual by means of handle 16 or the feeding motor 17, the feeding is arranged via a transmission, comprising a gear in the feeding housing and the rack 13. The feeding motor 17 can be disengaged from the gear by means of an extendable handle 20. When the motor is disengaged from the gear, the gear can instead be turned around by means of the handle 16.

In the feeding unit 19, there is also a closable valve for water supply for the cooling of the core drilling head 21, FIG. 1, of the drill 4. Forward and return hoses for the water have been designated 23 and 24 respectively. An ingoing electric feeding cable to the feeding unit 19 has been designated 26 and an outgoing electric cable to the drilling motor 6 has been designated 27. The drilling motor 6 is defined as the motor rotating the drill 4 around its rotational axis.

The device 10 also contains a control unit 30, which, via an electric cable 31, can be connected to the rear side of the feeding unit 19. The control unit 30 has the shape of a relatively small, portable box with a control panel 32 at the top side. Thereon is mounted a first control 33 and a second control 34. These controls 33, 34 have the shape of rotating knobs. The first control 33 is arranged for manual control of a first potentiometer 35, FIG. 4, for control of a torque regulator 36 for the feeding motor 17, which comprises a three-phase synchronous motor. The second control 34 is arranged for controlling a second potentiometer 38, FIG. 4, to influence a speed regulator 39 for the feeding motor 17. There are also devices in the control circuit for limiting the torque of the feeding motor 17. These devices, generally designated 40, comprise a current meter, generally designated 41, which gives a control value for the current to the feeding motor 17, the control value being fed to a comparator 42. A current transformer 43 in the feeding cable of the drilling motor 6 generates a current, which is representative for the load on the drilling motor. This current is fed back to the torque regulator 36, which compares the value of the potentiometer 35 and the current meter value, which is fed as a guide value to the torque limiter 42, which in turn feeds a torque limiting value to a pulse width modulator 45 in the feeding cable of the feeding motor 17.

The control unit 30 has a number of other functions, for instance a rotational speed indicator for the feeding motor 17. According to the embodiment, the rotational speed regulator constitutes a light 47, which is blinking with a frequency proportional to the rotational speed of the feeding motor 17, for example once per second if the rotational speed is 1 rotation per second. Furthermore, the control unit 30 shows five switches 52, namely a main switch 48 for the entire core-drilling device, a switch for activation and deactivation of the water valve in the feeding unit 19, a switch 49 for turning the drilling motor 6 on and off, a switch 50 for activating and deactivating an automatic stop for the feeding motor 17 and the drilling motor 6, when the drill 4 has penetrated through the working object or reached a certain preset depth in the object, and a toggle switch 51 for forward or backward operation of the feeding motor 17 or for a standstill. A mechanical stop 29, FIG. 2, can also be seen as included in the control function. The stop can be adjusted to a specified position on the pillar 2, representing a specified penetration depth for the drill 4 in the working object.

The core-drilling device 10 as described above including its control system is intended to function and be handled in the following manner. The starting point is the task to drill through for instance a concrete floor or to drill into a certain depth in a working object. In the latter case, the stop ring 29 on the pillar 2 is set to the position representing the specified depth. The main switch 48 is switched on and also the drilling motor switch 49. The feeding velocity of the feeding motor 17 is set to a specified value, hereafter named target value, by means of a turning control 34 that influences the rotational speed potentiometer 38. The core drill 4 with its core drilling head 21 is now to make initial contact with the working object. Instead of doing this manually by means of the handle 7, which in itself is possible according to previous practise, the initial contact according to the invention can be made from a distance by means of a control unit 30. This is arranged by means of the torque potentiometer 35 by setting it to a certain value by turning the control 33. Thus a current is generated, which is added to the current generated by the current transformer 43. These currents are fed into the torque generator 36.

The addition of the current from the torque potentiometer 35 has the same effect on the control system as a load increase on the drilling motor 6, which in turn results in reduced speed of the feeding motor 17 and consequently its initial contact force against the working object. This can also be noticed by the operator on the speed indicator, i.e. the blinking light 47. The operator can in this way influence the drilling machine's and the core drill's 4 feed towards the working object and, when the core drilling head 21 comes into contact with the working object, turn the control 33 to maximum deflection, with the consequence that the downward feed of the core drill 4 comes to a complete halt. From this position the operator can carefully apply onto the continuously rotating core drill 4 a certain initial force against the working object by turning the control 33 in the opposite direction.

By observing the blinking frequency of the indicator light 47, the operator receives information about the rotational speed of the feeding motor. The operator can also visually observe how the core drill 4 gradually penetrates into the working object. In this way, the operator can achieve a very smooth initial contact and control the initial contact force. This continues until the operator concludes that the core drill has penetrated sufficiently deeply into the working object to allow a higher feeding force in the continued drilling process, which is achieved by means of turning the control 33 sufficiently in the direction towards the zero position, i.e. where no current is generated from the potentiometer 35 and consequently no fictitious load is added to the real load on the drilling motor 6.

If no specified drilling depth has been preset by means of the stop ring 29, the core drill 4 will eventually fully penetrate trough the working object. During this process, the working current of approximately 10 ampere supplied to the drilling motor 6 is reduced to an idling current of approximately 4 ampere. This current decrease is detected in the circuit board in the control unit, since this is equipped with such a detector. Furthermore, the circuit board is so adjusted that the detected current decrease results in stopping of the device. If a certain preset depth is set by means of the stop ring 29 and if the feeding housing 5 contacts the stop ring 29, no more pulses are generated by the system, i.e. the rotational speed of the feeding motor 17 becomes zero. The indicator light 47 consequently stops blinking. When this has gone on for a certain period of time, as set in the circuit board, e.g. 4 seconds, the motor drive is also switched off by means of the automatic function integrated in the circuit board.

1. Core-drilling device comprising a drilling machine (3) with a core drill (4), a stand (2), a feeding housing that suspends the drilling machine and its movable along the stand, an electric drilling motor for rotation of the core drill in the drilling machine and a feeding unit (19) with an electric feeding motor (17) for feeding of the feeding housing along the stand, characterised in a control unit (30) that is electrically connected to the feeding unit, this feeding unit (30) comprising at least a first control (33) for manual influence of the feeding motor's (17) feeding force.

2. Device according to claim 1, characterised in that the feeding unit comprises a torque regulator (36) arranged to be influenced by the mentioned first control (33) for manual influence of the feeding motor's feeding force.

3. Device according to claim 1 or 2, characterised in that the feeding unit comprises a speed regulator (39) that can be manually influenced by means of a second control (34) on the control unit.

4. Device according to claim 2 characterised in that mentioned controls constitute potentiometers (35, 38).

5. Device according to claim 1, characterised in that the feeding unit comprises a torque limiting device for feeding the motor and that this device can be influenced by the mentioned first control.

6. Device according to claim 1, characterised in that the control unit constitutes a portable unit, which via at least one cable or via radio communication is electrically connected to the feeding unit.

7. Device according to claim 1, characterised in that the feeding unit also comprises means for controlling a water flow to the drilling head.

8. Device according to claim 1, characterised in that the control unit comprises controls for alternate forward and backward operation of the feeding housing and for stationary position of the feeding motor.

9. Device according to claim 1, characterised in that the control unit comprises a rotational speed indicator for the feeding motor.

10. Device according to claim 9, characterised in that the rotational speed indicator constitutes a light which is arranged to be switched on and off at a frequency in proportion to the rotational speed.

11. Device according to claim 1, characterised in that the control unit comprises an on-off control for automatic stopping of the system which comprises a feeding motor, drilling motor for rotation of the drill and for shutting off the water supply when the drill penetrates an object to be drilled or when the drill has reached a present depth in the working object.
